(19) United States
(12) Patent Application Publication
(10) Pub. No.: US 2012/0001970 A1
(43) Pub. Date: Jan. 5, 2012

(54) DROPLET EJECTION DEVICE AND DROPLET EJECTION METHOD

(75) Inventor: Hitoshi Satoh, Osaka (JP)

(73) Assignee: SHARP KABUSHIKI KAISHA, Osaka-shi, Osaka (JP)

(21) Appl. No.: 13/140,954

(22) PCT Filed: Nov. 6, 2009
(86) PCT No.: PCT/JP2009/068950

§ 371 Date: Jul. 12, 2011

(30) Foreign Application Priority Data
Dec. 18, 2008 (JP) 2008-321766

(51) Int. Cl. B41J 29/38

(52) U.S. Cl. 347/10

(57) ABSTRACT

A droplet ejection device in which cavitation is prevented and droplets are favorably ejected includes a nozzle, a liquid chamber communicating with the nozzle and arranged to house a material solution supplied through a liquid supply channel, a piezoelectric vibrator provided to the chamber, and a control mechanism arranged to apply driving voltage to the vibrator, and is arranged to eject droplets of the liquid from the nozzle by increasing and decreasing a volume of the chamber by the vibrator that is deformed in accordance with the voltage that is applied from the control mechanism, wherein the control mechanism is arranged to change the voltage, which is applied to the vibrator when the volume of the chamber is increased so as to suck the liquid into the chamber from the supply channel, in stages such that the volume of the chamber is increased in a plurality of stages.

### TECHNICAL FIELD

The present invention relates to a droplet ejection device and a droplet ejection method that are used for ejecting droplets of a material solution that contains alignment film material onto a liquid crystal display substrate by an inkjet method.

### BACKGROUND ART

In recent years, a liquid crystal display panel is widely used as a display unit of a household electrical appliance such as a personal computer and a television. In general, the liquid crystal display panel has a structure that a pair of substrates that are a thin film transistor (TFT) array substrate and a color filter (CF) substrate are opposed parallel to each other leaving a given gap therebetween, and liquid crystals are filled between the substrates. The TFT array substrate has a matrix arrangement of a plurality of pixel electrodes, and the CF substrate has a common electrode that covers almost all over the CF substrate. Alignment of the liquid crystals is controlled by changing voltages that are applied between the electrodes.

In order to control alignment of the liquid crystals, an alignment film made from organic material such as a polyimide usually covers the pixel electrodes and the common electrode. This alignment film is prepared by a method of forming a thin film made from alignment film material onto a substrate on which electrodes have been provided by using a rotary roller, or is prepared by a method of ejecting droplets of a material solution that contains alignment film material (an alignment film solution) onto a substrate with the use of a droplet ejection device in an inkjet method as shown in FIG. 6.

As shown in FIG. 6, ejection heads 100 are arranged staggered, and each ejection head 100 includes a plurality of nozzles 100d that are aligned at a predetermined pitch P along the X-direction. The ejection heads 100 are arranged to eject droplets 110 of alignment film material in succession from their nozzles 100d while being moved in the Y-direct ion relative to a substrate 130.

FIG. 7 shows a cross-sectional structure of the ejection head 100. The ejection head 100 is arranged to eject droplets 110 of alignment film material from the nozzle 100d that communicates with a liquid chamber 100a that accommodates a material solution 105 that contains alignment film material (for example, 5% polyimide resin, 95% solvent) that is supplied through a liquid supply channel 100g by increasing and decreasing the volume of the liquid chamber 100a with the use of a piezoelectric vibrator 100f that is deformed in accordance with an applied voltage.

As shown in FIG. 7, the liquid chamber 100a is provided to a head main body 100b that is located between a nozzle plate 100e in which the nozzle 100d is pierced and a flexible vibration plate 100c, and the material solution 105 is supplied from the liquid supply channel 100g to the liquid chamber 100a and stored in the liquid chamber 100a.

The piezoelectric vibrator 100f is adhered to a top surface of the vibration plate 100c. When the piezoelectric vibrator 100f is deformed by application of a driving voltage, the vibration plate 100c is displaced so as to change the volume of the liquid chamber 100a.

FIG. 8 is a view showing the waveform of the driving voltage that is applied to the piezoelectric vibrator 100f of the ejection head 100. FIG. 8 exemplary shows the waveform of the voltage that is disclosed in JP H08-281939 A. As shown in FIG. 8, a rectangular voltage having a rapid rising edge and a rapid trailing edge is applied to the piezoelectric vibrator 100f, and the vibration plate 100c is rapidly displaced in accordance with the application so as to increase and decrease the volume of the liquid chamber 100a, so that the droplets 110 are ejected from the nozzles 100d that communicate with the liquid chamber 100a.

To be more specific, as shown in FIG. 8, when a positive voltage of +20V is applied to the piezoelectric vibrator 100f that is in a standby mode in which a voltage applied to the piezoelectric vibrator 100f is 0V, the piezoelectric vibrator 100f is elastically deformed upward. In accordance with the deformation, the vibration plate 100c is also displaced upward to increase the volume of the liquid chamber 100a, and the material solution 105 is supplied to the liquid chamber 100a through the liquid supply channel 100d. By applying a negative voltage of −5V immediately after that, the piezoelectric vibrator 100f that has been elastically deformed upward is elastically deformed downward. In accordance with the deformation, the vibration plate 100c that has been displaced upward is also displaced downward to decrease the volume of the liquid chamber 100a, so that the material solution 105 is pushed out of the nozzles 100d so as to eject the droplets 100. Then, the voltage that has been applied to the piezoelectric vibrator 100f is restored from −5V to 0V, so that the piezoelectric vibrator 100f is restored to its original state in which the piezoelectric vibrator 100f is not elastically deformed. In accordance with the restoration, the volume of the liquid chamber 100 is decreased to some extent. At this time, the material solution 105 that is going to fall from the nozzles 100d following the droplets 100 is sucked into the nozzles 100d.

As shown in FIG. 6, the droplets 110 of alignment film material that are ejected from the nozzles 100d of the ejection heads 100 spread on the substrate 130 at the moment of landing. Contacting one another, the adjacent droplets 110 join together to be united and take the form of a single thin film in which the alignment film material is uniformly spread on the substrate 130. Then, the droplets 110 are subjected to a predetermined process such as a drying process to remove a solvent or substance other than the alignment film material contained in the droplets 110. Thus, an alignment film having a given thickness is formed on the substrate 130.

The pitch P, which defines a distance between the adjacent nozzles 100d, is several hundred μm, so that the droplets 110 of alignment film material that are ejected from the adjacent nozzles 100d do not overlap one another as shown in FIG. 9. In order that the adjacent droplets 110 join together to be united, the nozzles 100d are shifted in a nozzle alignment direction (the X-direction) by a half to quarter length of the pitch P (by a half to quarter pitch) each time, one movement in the Y-direction of the ejection heads 100 is finished, where a plurality of movements in the Y-direction of the ejection heads 100 are performed.

For example, assuming that the pitch P is 800 μm and the ejection heads 100 are shifted in the X-direction by 200 μm, which is a quarter length of the pitch P, four movements in the Y-direction of the ejection heads 100 for droplet ejection should be performed. The process of the droplet ejection in this example will be explained.

First, as shown in FIG. 9, the first movement in the Y-direction of the ejection heads 100 is made downward, which is indicated by the arrow 121, and the continuous droplets 110 of alignment film material form streams 111 in the Y-direction on the substrate 130. Then, as shown in FIG. 10, after the ejection heads 100 are shifted rightward in the X-direction by the quarter length of the pitch P (by the quarter pitch), which is indicated by the arrow 122, the second movement in the Y-direction of the ejection heads 100 is made upward, which is indicated by the arrow 123, and the droplets 110 of alignment film material form streams 112 on the substrate 130.

Then, as shown in FIG. 11, after the ejection heads 100 are shifted rightward in the X-direction by the quarter length of the pitch P, which is indicated by the arrow 124, the third movement in the Y-direction of the ejection heads 100 is made downward, which is indicated by the arrow 125, and the droplets 110 of alignment film material form streams 113 on the substrate 130. Finally, as shown in FIG. 12, after the ejection heads 100 are shifted rightward in the X-direction by the quarter length of the pitch P, which is indicated by the arrow 126, the fourth movement in the Y-direction of the ejection heads 100 is made upward, which is indicated by the arrow 127, and the droplets 110 of alignment film material form streams 114 on the substrate 130.

In other words, in order to fill the gaps between the streams 111 of the droplets 110 of alignment film material that are formed on the substrate 130 by the first movement in the Y-direction of the ejection heads 100 (indicated by the arrow 121) on the substrate 130 as shown in FIG. 9, the second, third, and fourth movements in the Y-direction of the ejection heads 100 (indicated by the arrows 123, 125, 127) are made while the ejection heads 100 are gradually shifted in the X-direction by the predetermined lengths (quarter pitches) (indicated by the arrows 122, 124, 126). Thus, the formed adjacent streams 111, 112, 113 and 114 of the droplets 110 of alignment film material join together, whereby the droplets 110 are united as shown in FIG. 6.

The droplets 110, which are united by the joining adjacent streams 111, 112, 113, and 114 that are made by the two reciprocating movements in the Y-direction of the ejection heads 100 on the substrate 130 with the ejection heads 100 shifted gradually in the X-direction, are subjected to a drying process, and take the form of a single thin film on the substrate 130, which defines an alignment film.

### CITATION LIST

### Patent Literature

Patent Literature 1: JP H08-281939 A
Patent Literature 2: JP 2008-207354 A

### SUMMARY OF INVENTION

### Solution to Problem

However, there are problems that some of the nozzles 100a of the ejection heads 100 are clogged, so that the amounts of the droplets 110 ejected from those defective nozzles 100a could be small, or no droplets 110 are ejected.

When the streams 111, 112, 113 and 114 of the droplets 110 of alignment film material are formed by the two reciprocating movements in the Y-direction of the ejection heads 100 with the ejection heads 100 shifted gradually in the X-direction as described above while the nozzles 100a include such defective nozzles that eject the droplets 110 of inappropriate amounts as described above, the streams 111, 112, 113 and 114 of the droplets 110 of alignment film material that are ejected from defective nozzles 100b (circled with dotted lines in FIG. 13) that eject the droplets 110 of inappropriate amounts are formed adjacent to each other as shown in FIG. 13. Because the amounts of the droplets 110 of these streams are all smaller than the others as shown in FIG. 13, the amounts of alignment film material in these streams are smaller than the others.

When a substrate that includes portions on which the amounts of alignment film material are inappropriate as described above is subjected to a predetermined process such as a drying process, portions of an alignment film formed on the substrate that have thicknesses smaller than the other portions gather together so as to appear as visible defects 141 in the form of line defects in image display of a liquid crystal display panel 140 as shown in FIG. 14.

The substrate that has the portions on which the amounts of the droplets of alignment film material are inappropriate may be left standing for a given length of time until the inappropriate amounts of the droplets of alignment film material on the portions and the appropriate amounts of the droplets of alignment film material on the other portions become uniform or may be vibrated so that the inappropriate amounts of the droplets of alignment film material on the portions and the appropriate amounts of the droplets of alignment film material on the other portions become uniform. However, such an increase in the number of production processes increases the production cost.

A leading cause of the clogging of the nozzle 100d of the ejection head 100 is such that a gas such as nitrogen dissolved in the material solution 105 in the liquid chamber 100a appears as air bubbles 107 as shown in FIG. 15A, i.e., so-called cavitation (formation of empty cavities in a liquid by evaporation of fluid or separation of a dissolved gas in locally low pressure portions in the flows of the fluid) occurs, and the appearing air bubbles 17 hinder pushing out of the material solution 105 so as to cause ejection failure.

By the application of the voltage with the rapid rising edge (+20V) to the piezoelectric vibrator 100f in the standby state (0V) as shown in FIG. 8, an abrupt change to the negative pressure is caused inside the liquid chamber 100a at the moment of the upward displacement of the vibration plate 100c when the material solution 105 is supplied to the liquid chamber 100a through the liquid supply channel 100g as shown in FIG. 15A, which makes the gas dissolved in the material solution 105 appear as the air bubbles 107. If the ejection is performed in the state that the air bubbles 107 appear as shown in FIG. 15B, the amount of ejected droplets is small, or no droplets are ejected in some cases.

In order to prevent occurrence of cavitation, JP 2008-207354 A discloses an art of making the rising edge of the applied voltage to the piezoelectric vibrator 100f have a gentle curve as shown by the dotted lines of the waveform of the voltage shown in FIG. 8. However, the gentle rising edge of the voltage cannot prevent occurrence of cavitation in some cases.

An object of the present invention is to overcome the problems described above and to provide a droplet ejection device and a droplet ejection method in which occurrence of cavitation is prevented and droplets are favorably ejected.

### Solution to Problem

Preferred embodiments of the present invention provide a droplet ejection device that comprises a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism, wherein the control mechanism is arranged to change the driving voltage, which is applied to the piezoelectric vibrator when increasing the volume of the liquid chamber so as to suck the material solution into the liquid chamber from the liquid supply channel, in stages such that the volume of the liquid chamber is increased in a plurality of stages.

Preferred embodiments of the present invention also provide a droplet ejection device that comprises a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism, wherein the control mechanism is arranged to change the driving voltage, which is applied to the piezoelectric vibrator so as to eject the material solution from the nozzle, in three stages of a step-like first voltage waveform in which the volume of the liquid chamber is increased to be greater than the volume in a standby state in a plurality of stages so as to suck the material solution from the liquid supply channel into the liquid chamber, a rectangular second voltage waveform in which the volume of the liquid chamber is decreased to be smaller than the volume in the standby state so as to eject the droplets of the material solution from the nozzle, and a third voltage waveform in which the volume of the liquid chamber is restored to the volume in the standby state.

Preferred embodiments of the present invention also provide a droplet ejection method for a droplet ejection device that includes a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism, wherein the control mechanism is arranged to change the driving voltage, which is applied to the piezoelectric vibrator when increasing the volume of the liquid chamber so as to suck the material solution into the liquid chamber from the liquid supply channel, in stages such that the volume of the liquid chamber is increased in a plurality of stages.

Preferred embodiments of the present invention also provide a droplet ejection method for droplet ejection device that comprises a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism, wherein the control mechanism is arranged to change the driving voltage, which is applied to the piezoelectric vibrator so as to eject the material solution from the nozzle, in three stages of a step-like first voltage waveform in which the volume of the liquid chamber is increased to be greater than the volume in a standby state in a plurality of stages so as to suck the material solution from the liquid supply channel into the liquid chamber, a rectangular second voltage waveform in which the volume of the liquid chamber is decreased to be smaller than the volume in the standby state so as to eject the droplets of the material solution from the nozzle, and a third voltage waveform in which the volume of the liquid chamber is restored to the volume in the standby state.

### Advantageous Effects of Invention

In the droplet ejection device and the droplet ejection method having the configurations described above in which the driving voltage, which is applied to the piezoelectric vibrator so as to increase the volume of the liquid chamber and suck the material solution into the liquid chamber from the liquid supply channel, is changed in phases such that the volume of the liquid chamber is increased in a plurality of stages, negative pressure is gradually generated in the liquid chamber, which prevents a conventional abrupt change to the negative pressure in the liquid chamber. In other words, the voltage is changed in stages so that the volume of the liquid chamber is increased in a plurality of stages, so that the change in the pressure in the liquid chamber filled with the material solution may become a gradual change to the negative pressure.

Thus, occurrence of cavitation in the liquid chamber is prevented, and as a result, air bubbles do not easily appear in the liquid chamber, so that a problem that the amount of ejected droplets is small or no droplets are ejected is prevented.

Occurrence of cavitation in the liquid chamber when sucking the material solution is prevented by changing in the first stage the driving voltage, which is applied to the piezoelectric vibrator by the control mechanism, with the step-like first voltage waveform in which the volume of the liquid chamber is increased so as to be greater than the volume in a standby state in a plurality of stages and the material solution is sucked into the liquid chamber from the liquid supply channel. The material solution that is pushed out of the liquid chamber can be ejected as the droplets from the nozzle by changing in the second stage the driving voltage, which is applied to the piezoelectric vibrator by the control mechanism, with the second voltage waveform in which the volume of the liquid chamber is decreased so as to be smaller than the volume in the standby state and the droplets of the material solution are ejected from the nozzle. The material solution is prevented from falling from the nozzle and the droplets are favorably ejected by changing in the third stage the driving voltage, which is applied to the piezoelectric vibrator by the control mechanism, with the third voltage waveform in which the volume of the liquid chamber is restored to the volume in the standby state.

By changing the driving voltage, which is applied to the piezoelectric vibrator so as to eject the droplets from the nozzle, in the three stages of the first voltage waveform, the second voltage waveform, and the third voltage waveform, occurrence of cavitation in the liquid chamber is prevented so as to prevent air bubbles, and the droplets are favorably ejected in succession.

### BRIEF DESCRIPTION OF DRAWINGS

FIG. 1 is a view schematically showing a configuration of a droplet ejection device according to one preferred embodiment of the present invention.

FIG. 2 is a view showing a state in which droplets of alignment film material are ejected onto a substrate by an ejection head of the droplet ejection device in FIG. 1.

FIG. 3 is a view showing a schematic configuration of a liquid crystal display panel.

FIG. 4 is a view showing a cross-sectional structure of the ejection head of the droplet ejection device in FIG. 1.

FIG. 5 is a view showing in chronological order a waveform of a driving voltage that is applied to the piezoelectric vibrator of the ejection head in FIG. 4.

FIG. 6 is a view showing a state in which droplets of alignment film material are ejected onto a substrate by a conventionally used droplet ejection device.

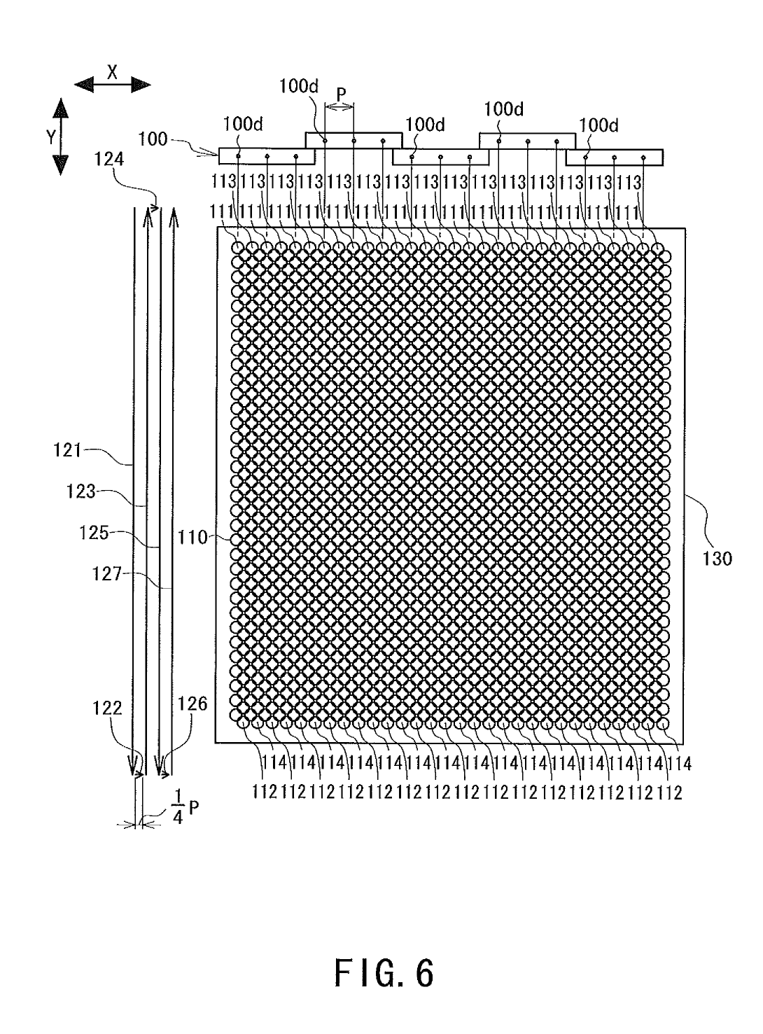

FIG. 7 is a view showing a cross-sectional structure of an ejection head of the droplet ejection device in FIG. 6.

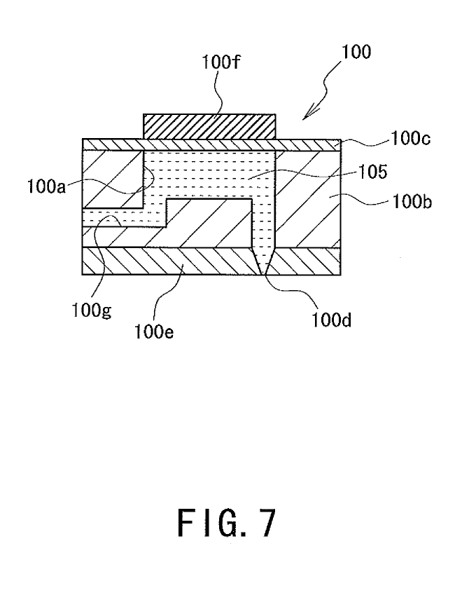

FIG. 8 is a view showing in chronological order a waveform of a driving voltage that is applied to a piezoelectric vibrator of the ejection head in FIG. 7.

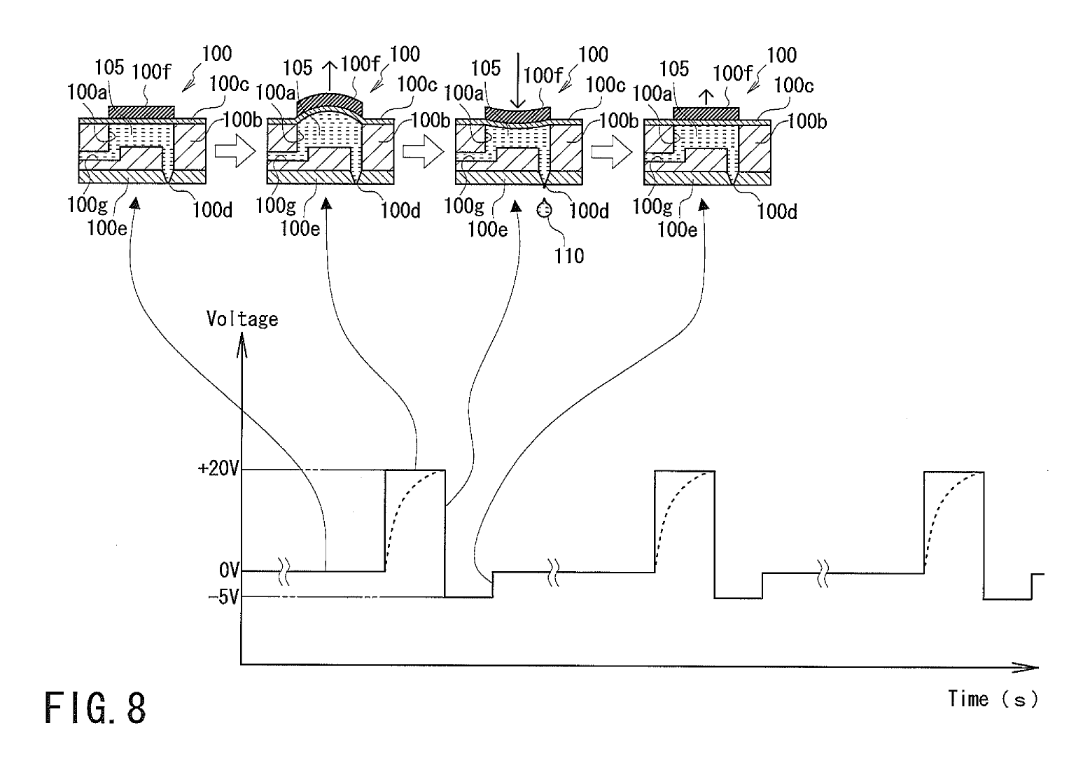

FIG. 9 is a view showing a state in which a first stream of the droplets of alignment film material is formed on the substrate by a first movement of the ejection head in FIG. 6.

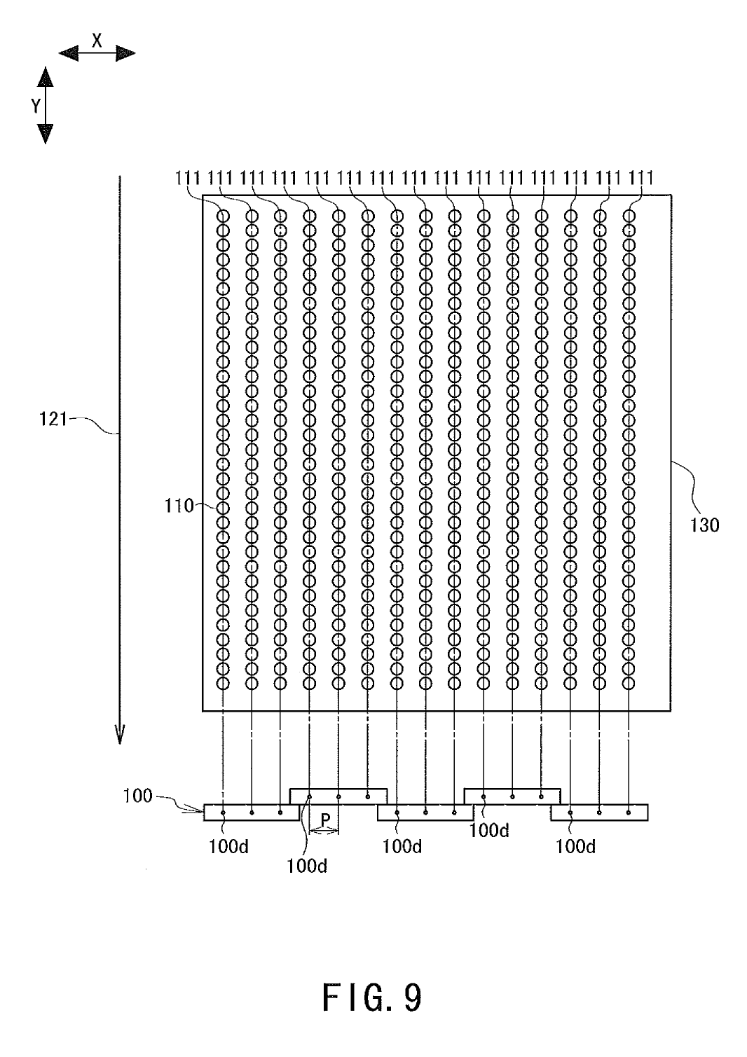

FIG. 10 is a view showing a state in which a second stream of the droplets of alignment film material is formed on the substrate by a second movement of the ejection head in FIG. 6.

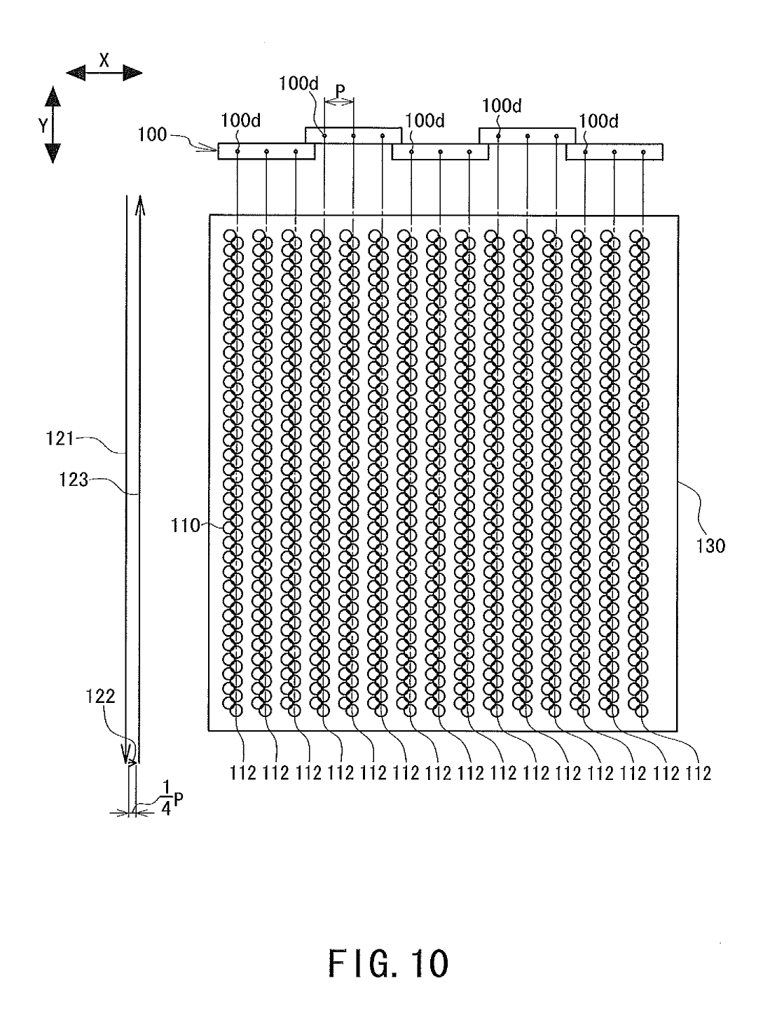

FIG. 11 is a view showing a state in which a third stream of the droplets of alignment film material is formed on the substrate by a third movement of the ejection head in FIG. 6.

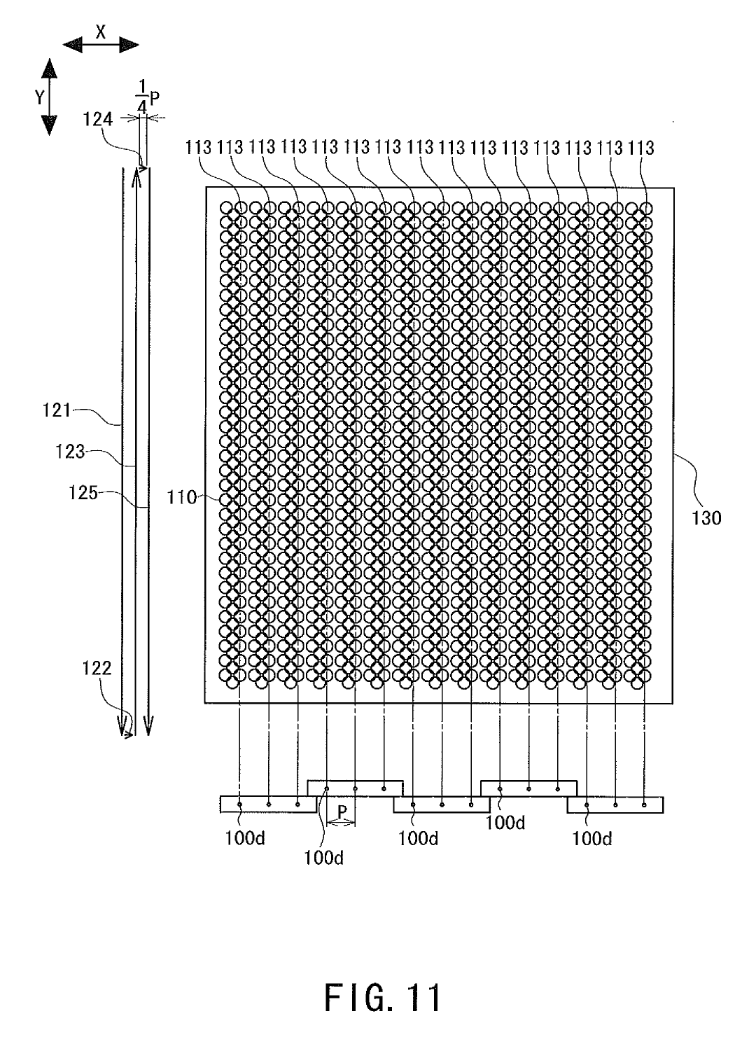

FIG. 12 is a view showing a state in which a fourth stream of the droplets of alignment film material is formed on the substrate by a fourth movement of the ejection head in FIG. 6.

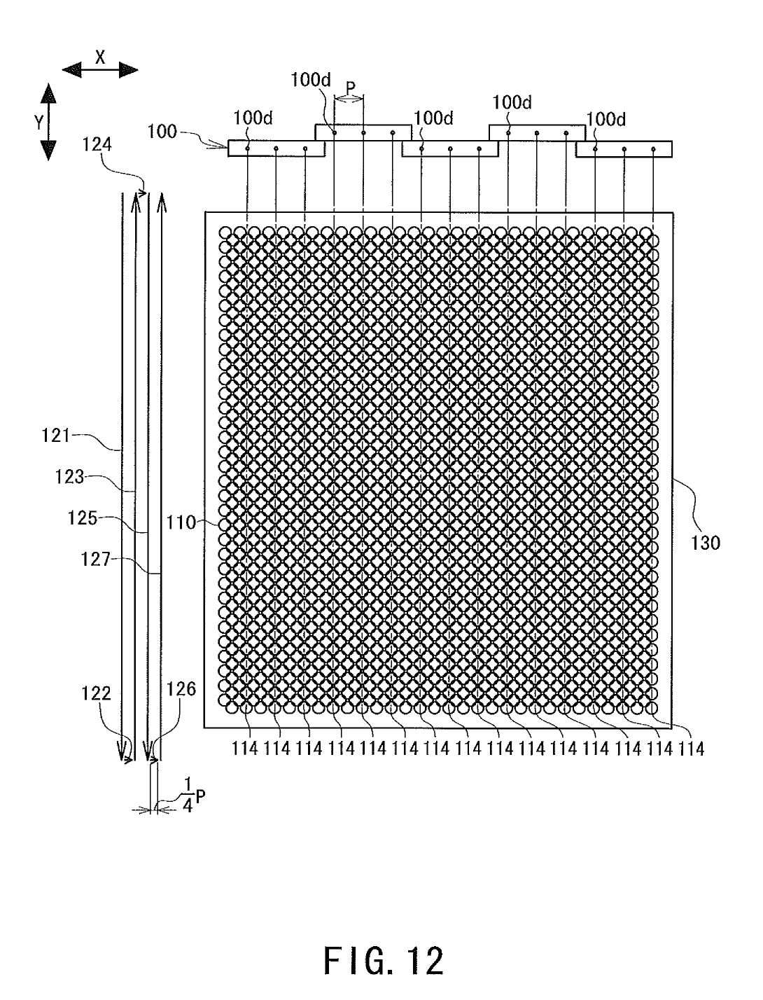

FIG. 13 is a view showing an ejection state in a case where defective nozzles that have inappropriate amounts of ejected droplets are included in the ejection head in FIG. 6.

FIG. 14 is a view showing a state in which visible defects in the form of line defects are found in image display of a liquid crystal display panel.

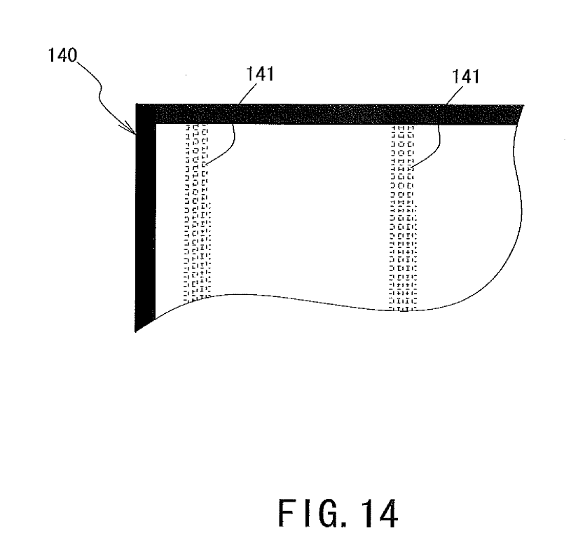

FIG. 15A is a cross-sectional view showing a state in which air bubbles appear due to cavitation in a liquid chamber of the ejection head, and FIG. 15B is a cross-sectional view showing a state in which droplets are ejected in the state in FIG. 15A.

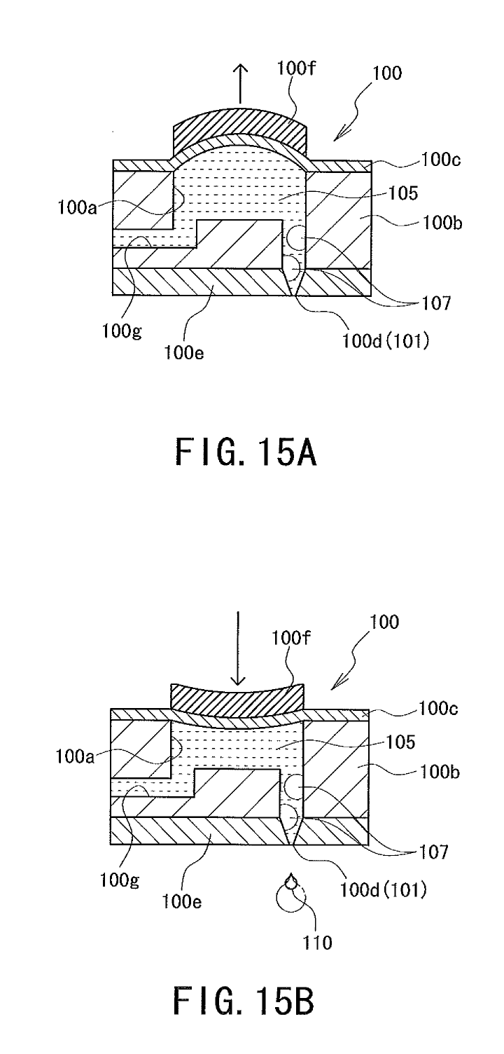

### DESCRIPTION OF EMBODIMENTS

A detailed description of a droplet ejection device and a droplet dejection method according to one preferred embodiment of the present invention will now be provided with reference to the accompanying drawings.

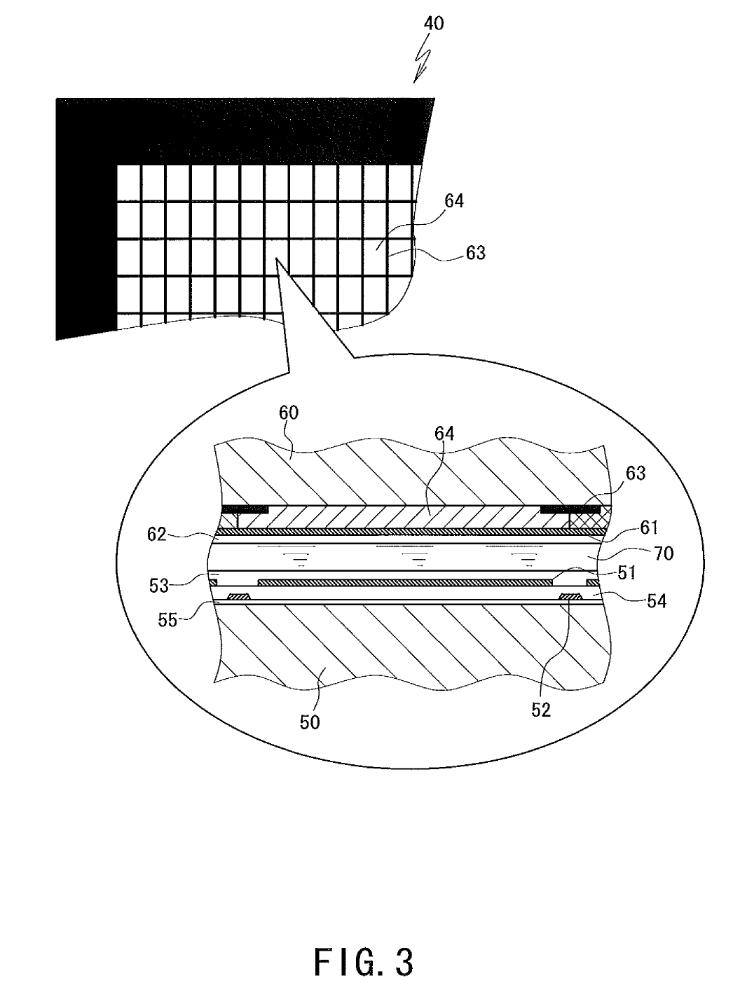

A description of a liquid crystal display panel to which the droplet ejection device according to the present invention is applied is provided first. FIG. 3 provides a plan schematic view of a liquid crystal display panel 40 and a sectional schematic view of one pixel of the panel 40. As shown in FIG. 3, the liquid crystal display panel 40 has a configuration such that a plurality of pixels are arranged in the vertical direction and in the horizontal direction. As shown in the sectional schematic view of FIG. 3, the liquid crystal display panel 40 includes a glass substrate (TFT array substrate) 50 and a glass substrate (color filter substrate) 60 that are opposed to each other, between which liquid crystals 70 are filled. Pixel electrodes 51 are each provided to the pixels and are arranged in a matrix on the top surface of the lower glass substrate 50. A common electrode 61 is provided almost entirely on the under surface of the upper glass substrate 60. The pixel electrodes 51 and the common electrode 61 are preferably made of ITO (Indium-Tin Oxide).

Source electrodes 52 and gate electrodes (not shown) are provided perpendicular to each other so as to surround each of the pixel electrodes 51. The source electrodes 52 and the gate electrodes intersect with each other such that the source electrodes 52 lie on the gate electrodes at their intersections with a gate insulator 55 sandwiched therebetween. TFTs (thin film transistors) (not shown) are each provided at the intersections and connected to the pixel electrodes via drain electrodes (not shown). With this configuration, the TFTs are on/off controlled by voltages of scanning signals supplied from the gate electrodes while voltages of image display signals supplied from the source electrodes 52 are applied to the pixel electrodes 51 via the drain electrodes. In addition, the pixel electrodes 51 are each disposed in regions surrounded by the source electrodes 52 and the gate electrodes with an interlayer insulating film 54 sandwiched between the pixel electrodes 51 and the source electrodes 52 and the gate electrodes as shown in FIG. 3.

An alignment film 53 is provided on the glass substrate 50 including the pixel electrodes 51 such that the pixel electrodes 51 are coated with the alignment film 53. An alignment film 62 is provided on the glass substrate 60 including the common electrode 61 such that the common electrode 61 is coated with the alignment film 62. Subjecting these alignment films 53 and 62 to rubbing processing for rubbing surfaces of the alignment films 53 and 62 in a given direction preferably with the use of a silk cloth, or to photo-alignment processing for irradiating surfaces of the alignment films 53 and 62 in a given direction preferably with ultraviolet light provides the surfaces of the alignment films 53 and 62 with predetermined alignment characteristics, which can bring the liquid crystals 70 that are in contact with the alignment films 53 and 62 into alignment. The alignment films 53 and 62 are made from a polyimide.

A black matrix 63 is provided on the glass substrate 60 including the common electrode 61. The black matrix 63 is arranged to shield regions of the glass substrate 50 where the source electrodes 52, the gate electrodes, and the TFTs are formed from light. Color layers 64 of red (R), green (G), and blue (B) colors are each provided in the pixels.

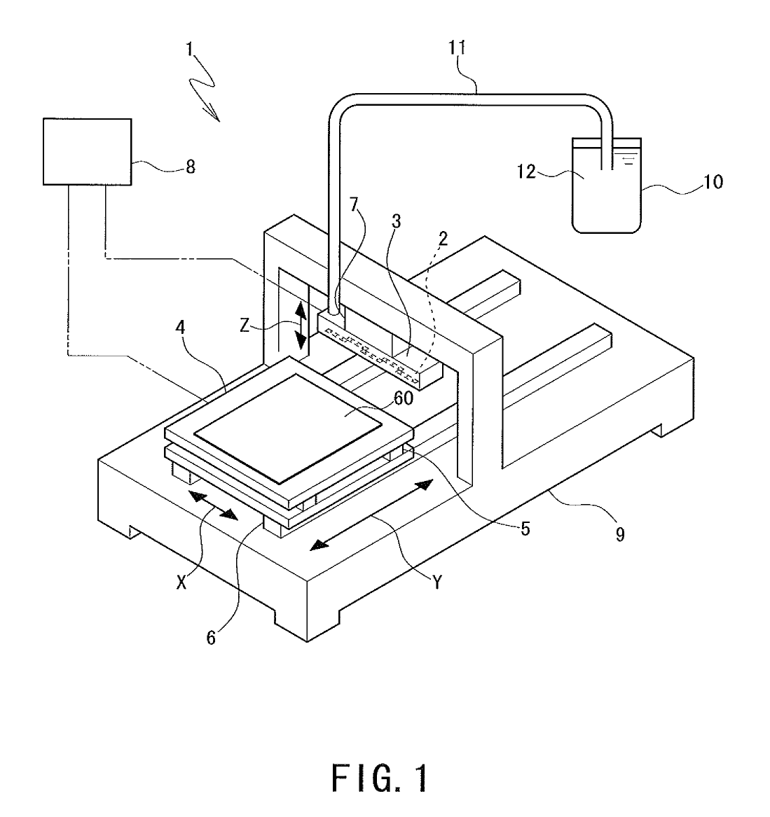

FIG. 1 is a view showing a schematic configuration of the droplet ejection device that ejects droplets of alignment film material that is used in the formation of the alignment film 53 on the glass substrate (TFT array substrate) 50 and in the formation of the alignment film 62 on the glass substrate (color filter substrate) 60, which glass substrates are included in the liquid crystal display panel 40 having the configuration described above. A description of the formation of the alignment film 62 on the glass substrate (color filter substrate) 60 will be provided. A description of the formation of the alignment film 53 on the glass substrate (TFT array substrate) 50 is omitted because the formation of the alignment film 53 is similar to the formation of the alignment film 62 on the glass substrate (color filter substrate) 60.

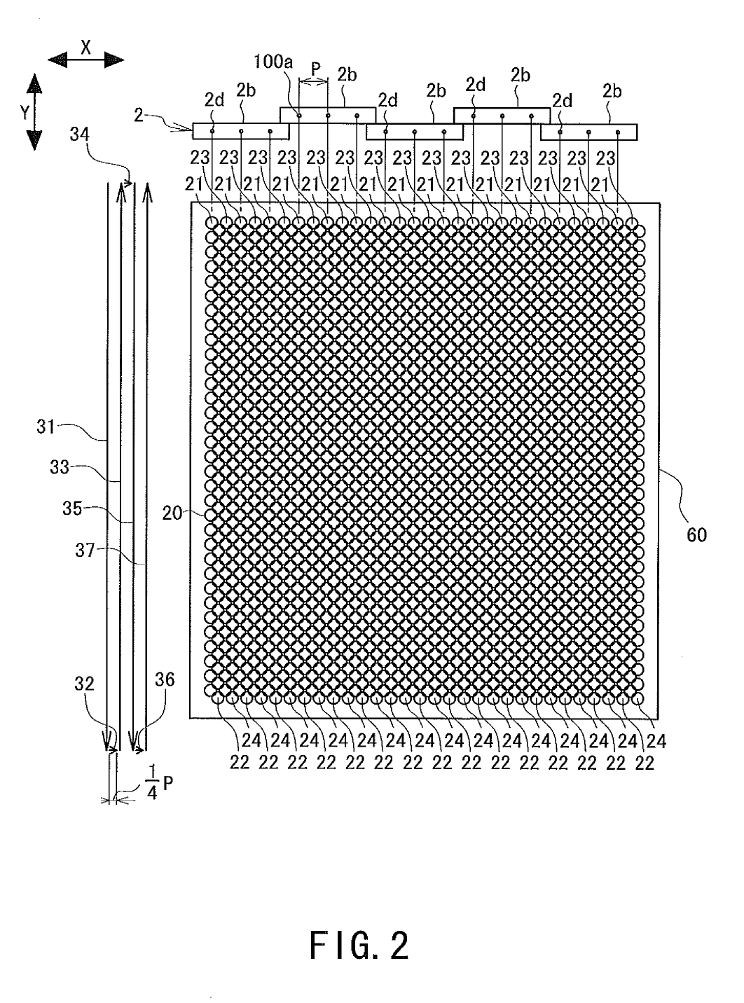

As shown in FIG. 1, a droplet ejection device 1 includes a head-fixing table 3 to which a plurality of ejection heads 2 shown in FIG. 2 are fixed on its undersurface, and a substrate stage 4 that allows movement in the X-direction and movement in the Y-direction of the glass substrate 60 relative to the ejection heads 2 that are fixed to the head-fixing table 3.

The substrate stage 4 is arranged to support the glass substrate 60 on its top surface such that the glass substrate 60 adheres thereto. Thus, the substrate stage 4 allows the movement in the X-direction and the movement in the Y-direction of the glass substrate 60 relative to the ejection heads 2. To be specific, the substrate stage 4 is made movable by a first slider 5 in a direction parallel to a direction in which nozzles 2d of the ejection heads 2 are aligned (the X-direction), and is made movable by a second slider 6 in a direction perpendicular to the nozzle alignment direction (the Y-direction). In addition, the device 1 includes a hoisting and lowering mechanism 7 by which the substrate stage 4 is made movable also in a vertical direction (the Z-direction) in order to adjust the distance between the glass substrate 60 and the ejection heads 2. The device 1 includes a control mechanism 8 that controls the movement of the slider 5, the movement of the slider 6, and the movement of the hoisting and lowering mechanism 7, and controls the movement for droplet ejection of the ejection heads 2. The device 1 includes a device table 9 on which the substrate stage 4, the sliders 5 and 6, and the hoisting and lowering mechanism 7 are disposed.

The device 1 is arranged such that a material solution 12 that contains alignment film material (e.g., 5% polyimide resin, 95% solvent) is fed under pressure from a feed tank 10 into the ejection heads 2 provided on the undersurface of the head-fixing table 3 via a feed pipe 11.

As shown in FIG. 2, the ejection heads 2 are arranged staggered along the X-direction on the undersurface of the head-fixing table 3. Each ejection head 2 includes the nozzles 2d that are aligned at a predetermined pitch P along the X-direction. Having this configuration, the ejection heads 2 are arranged to eject droplets 20 of the material solution 12 that contains alignment film material entirely onto the glass substrate 60 by a droplet ejection method.

For the sake of simple explanation of the droplet ejection method to be described later, indicated by the arrows 31 to 37 in FIG. 2 are the moving directions of the ejection heads 2 relative to the glass substrate 60, while the device 1 actually has the configuration that the movement of the first slider 5 and the movement of the second slider 6 move the glass substrate 60 supported by the substrate stage 4 in the X- and Y-directions relative to the ejection heads 2 that are fixed to a middle portion of the device table 9 of the device 1 as shown in FIG. 1.

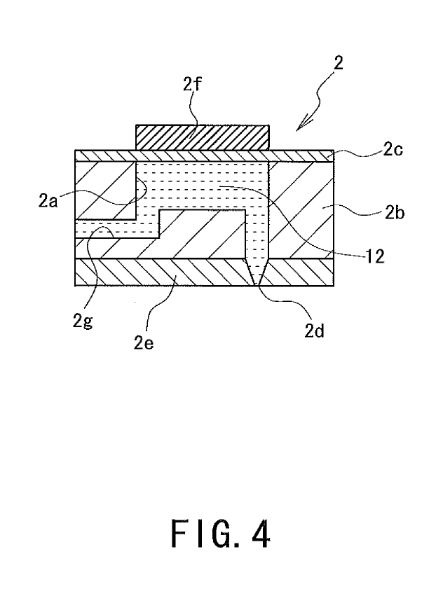

As shown in FIG. 4, each ejection head 2 includes a head main body 2b in which a liquid chamber 2a accommodating the material solution 12 is provided, a flexible vibration plate 2c arranged to seal the liquid chamber 2a, and a nozzle plate 2e that is provided to the head main body 2b and in which nozzle 2d that communicates with the liquid chamber 2a is pierced.

The head main body 2b has the shape of a prism. A plurality of liquid chambers 2a are in compartment formation at given intervals along the long direction of the head main body 2b. The liquid chambers 2a each accommodate the material solution 12.

The liquid chamber 2a has openings on the top surface and the bottom surface of the head main body 2b. The opening on the top surface is closed by the vibration plate 2c, and the opening on the bottom surface is closed by the nozzle plate 2e. The nozzle 2d that communicates with the liquid chamber 2a is provided to the nozzle plate 2e.

A plate-shaped piezoelectric vibrator 2f is adhered to a surface of the vibration plate 2c opposite to the liquid chamber 2a, and a given driving voltage is applied to the piezoelectric vibrator 2f from the control mechanism 8. When the driving voltage is applied from the control mechanism 8 to the piezoelectric vibrator 2f so as to vibrate the vibration plate 2c and apply pressure to the material solution 12 in the liquid chamber 2a, the material solution 12 is ejected in the form of droplets from the nozzles 2d.

The head main body 2b is provided with a liquid supply channel 2g an end of which communicates with the liquid chamber 2a. The other end of the liquid supply channel 2g defines an opening on the side of the head main body 2b, and is connected to a supply tank 10 through a supply pipe 11. Thus, the liquid chamber 2a is filled with the material solution 12.

The ejection head 2 is arranged to eject the droplets 20 of alignment film material from the nozzle 2d that communicates with the liquid chamber 2a that accommodates the material solution 12 of alignment film material that is supplied through the liquid supply channel 2g by increasing and decreasing the volume of the liquid chamber 2a with the use of the piezoelectric vibrator 2f that is deformed in accordance with the applied voltage.

When the piezoelectric vibrator 2f is deformed by application of the voltage, the vibration plate 2c is displaced to change the volume of the liquid chamber 2a. When a positive voltage is applied, the piezoelectric vibrator 2f is elastically deformed upward. In accordance with the deformation, the vibration plate 2c is also displaced upward to increase the volume of the liquid chamber 2a. When a negative voltage is applied, the piezoelectric vibrator 2f is elastically deformed downward. In accordance with the deformation, the vibration plate 2c is also displaced downward to decrease the volume of the liquid chamber 2a.

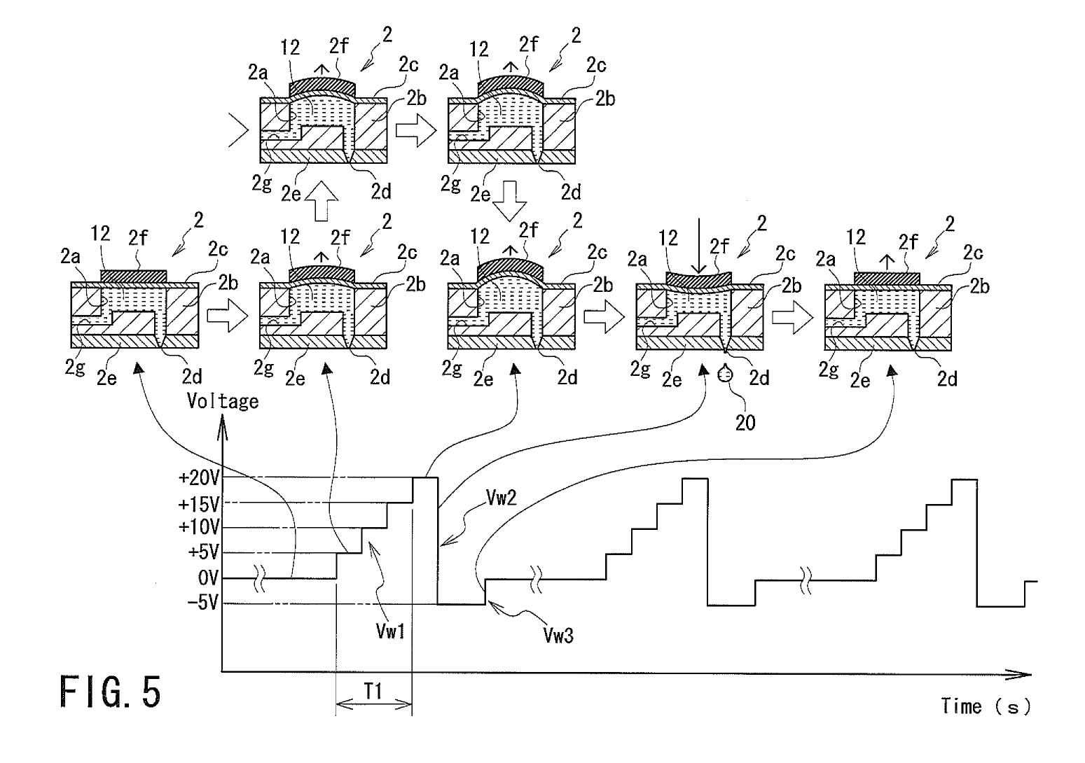

FIG. 5 is a view showing in chronological order a waveform of the driving voltage that is applied from the control mechanism 8 to the piezoelectric vibrator 2f. As shown in FIG. 5, the driving voltage that is applied to the piezoelectric vibrator 2f is changed in three phases of a step-like first voltage waveform Vw1 in which the voltage rises in four stages from the voltage of 0V in a standby state toward the positive voltage side in a period T1, a rectangular second voltage waveform Vw2 in which the voltage drops in one stage from the first voltage waveform Vw1 toward the negative voltage side, and a rectangular third voltage waveform Vw3 in which the voltage rises in one stage from the second voltage waveform Vw2 to the voltage of 0V in the standby state.

The first voltage waveform Vw1 depicts the waveform of a voltage that is applied to the piezoelectric vibrator 2f immediately before an ejection operation begins in the standby mode in which the voltage applied to the piezoelectric vibrator 2f is 0V. As shown in FIG. 5, the first voltage waveform Vw1 does not rise abruptly to +20V but changes in stages in the period T1 in a step-like manner such that the applied voltage is increased to +5V, +10V, +15V, and +20V. Thus, the upward deformation of the piezoelectric vibrator 2f also occurs in stages in accordance with the applied voltages of +5V, +10V, +15V, and +20V, and accordingly, the vibration plate 2c is also deformed upward in stages, so that the volume of the liquid chamber 2a is increased in stages.

Owing to the change in stages when the volume of the liquid chamber 2a is increased so as to suck the material solution 12 into the liquid chamber 2a through the liquid supply channel 2g, the change in the pressure in the liquid chamber 2a filled with the material solution 12 can be made into a gradually change to the negative pressure. In other words, the negative pressure generated in the liquid chamber 2a is changed in stages, so that cavitation that occurs due to an abrupt change to the negative pressure can be prevented.

When the voltage of −5V with the second voltage waveform Vw2 is applied to the piezoelectric vibrator 2f immediately after the first voltage waveform Vw1, the piezoelectric vibrator 2f that has been elastically deformed upward is elastically deformed downward as shown in FIG. 5. In accordance with the deformation, the vibration plate 2c that has been displaced upward is also displaced downward to decrease the volume of the liquid chamber 2a, so that the material solution 12 is push out of the nozzles 2d so as to eject the droplets 20. After then, immediately after the second voltage waveform Vw2, the third voltage waveform Vw3 that makes the voltage of −5V that has been applied to the piezoelectric vibrator 2f be 0V is applied to the piezoelectric vibrator 2f, so that the piezoelectric vibrator 2f is restored to the standby state in which the piezoelectric vibrator 2f is not elastically deformed. In accordance with the restoration, the vibration plate 2c is displaced upward to slightly increase the volume of the liquid chamber 2a. At this time, the material solution 12 that is going to fall from the nozzles 2d following the droplets 20 is sucked into the nozzles 2d.

By repeating the change of the voltage that is applied to the piezoelectric vibrator 2f of the ejection head 2 with the first voltage waveform Vw1, the second voltage waveform Vw2, and the third voltage waveform Vw3 in order, the droplets 20 can be ejected in succession.

By relatively moving the ejection head 2 that ejects the droplets 20 from the nozzles 2d in succession with respect to the glass substrate 60, the droplets 20 are ejected onto the glass substrate 60 as shown in FIG. 2.

The pitch P, which defines a distance between the adjacent nozzles 2d, is 800 μm, for example, so that the droplets 20 of alignment film material that are ejected from the adjacent nozzles 2d do not overlap one another. In order that the adjacent droplets 20 join together to be united, the nozzles 2d are shifted in the nozzle alignment direction (the X-direction) by a half to quarter length of the pitch P (by a half to quarter pitch) each time one movement in the Y-direction of the ejection heads 2 is finished, where three movements in the Y-direction of the ejection heads 2 are performed. Thus, four movements in the Y-direction of the ejection heads 2 for droplet ejection should be performed.

To be more specific, the first movement in the Y-direction of the ejection heads 2 is made downward, which is indicated by the arrow 31, and the continuous droplets 20 of alignment film material form streams 21 in the Y-direction on the substrate 60. Then, as shown in FIG. 2, after the ejection heads 2 are shifted rightward in the X-direction by the quarter length of the pitch P (by the quarter pitch), which is indicated by the arrow 32, the second movement in the Y-direction of the ejection heads 2 is made upward, which is indicated by the arrow 33, and the droplets 20 of alignment film material form streams 22 on the substrate 60.

Then, as shown in FIG. 2, after the ejection heads 2 are shifted rightward in the X-direction by the quarter length of the pitch P, which is indicated by the arrow 34, the third movement in the Y-direction of the ejection heads 2 is made downward, which is indicated by the arrow 35, and the droplets 20 of alignment film material form streams 23 on the substrate 60. Then, as shown in FIG. 2, after the ejection heads 2 are shifted rightward in the X-direction by the quarter length of the pitch P, which is indicated by the arrow 36, the fourth movement in the Y-direction of the ejection heads 2 is made upward, which is indicated by the arrow 37, and the droplets 20 of alignment film material form streams 24 on the substrate 60.

In order to fill the gaps between the streams 21 of the droplets 20 of alignment film material that are formed on the substrate 60 by the first movement in the Y-direction of the ejection heads 2 (indicated by the arrow 31) on the substrate 60, the second, third and fourth movements in the Y-direction of the ejection heads (indicated by the arrows 33, 35, 37) are made while the ejection heads 2 are gradually shifted in the X-direction by the predetermined lengths (quarter pitches) (indicated by the arrows 32, 34, 36). Thus, the formed adjacent streams 21, 22, 23 and 24 of the droplets 20 of alignment film material join together, whereby the droplets 20 are united as shown in FIG. 2.

The droplets 20, which are united by the joining adjacent streams 21, 22, 23 and 24 that are made by the two reciprocating movements in the Y-direction of the ejection heads 2 on the substrate 60 with the ejection heads 2 shifted gradually in the X-direction, are subjected to a drying process, and take the form of a single thin film on the substrate 60, which defines an alignment film 62.

Owing to the droplet ejection device 1 according to the present invention in which the driving voltage that is applied to the piezoelectric vibrator 2f in order to increase the volume of the liquid chamber 2a and suck the material solution 12 into the liquid chamber 2a from the liquid supply channel 2g is changed in stages in order to increase the volume of the liquid chamber 2a in a plurality of stages, the negative pressure is gradually generated in the liquid chamber 2a, which prevents the abrupt occurrence of the negative pressure in the liquid chamber 100a in the conventional ejection head 100.

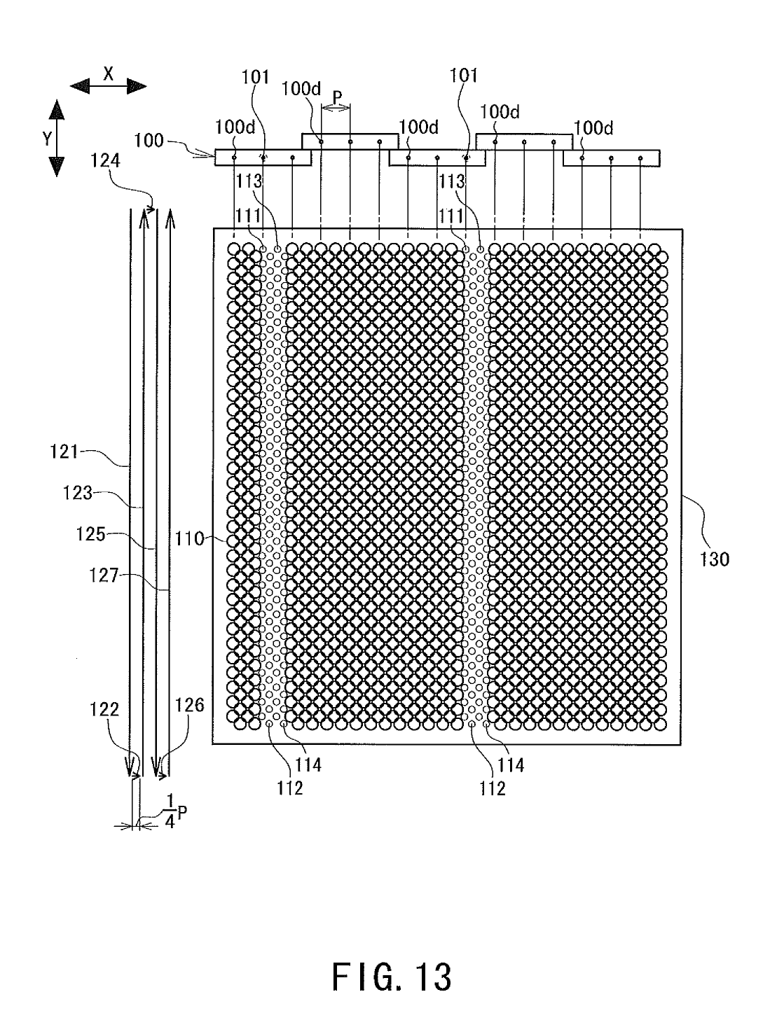

Accordingly, occurrence of cavitation in the liquid chamber 2a is prevented, and as a result, air bubbles hardly appear in the liquid chamber 2a. Thus, problems that the amount of ejected droplets 20 is small or no droplets 20 are ejected are prevented. Accordingly, defective nozzles that have inappropriate amounts of ejected droplets shown in FIG. 13 in the prior art are prevented, which allows for favorable ejection of the droplets onto the substrate.

To be more specific, the voltage that is applied to the piezoelectric vibrator 2f of the ejection head 2 is changed by the step-like first voltage waveform Vw1 in which the volume of the liquid chamber 2a is increased in a plurality of stages so as to be larger than the volume in the standby state and the material solution 12 is sucked into the liquid chamber 2a from the liquid supply channel 2g. As a result, the negative pressure is gradually generated in the liquid chamber 2a, which prevents cavitation that occurs due to an abrupt change to the negative pressure.

By changing the voltage that is applied to the piezoelectric vibrator 2f, to which the voltage has been applied with the first voltage waveform Vw1, with the rectangular second voltage waveform Vw2 in which the volume of the liquid chamber 2a is decreased so as to be smaller than the volume in the standby state and the droplets 20 are ejected from the nozzles 2d, the material solution 12 that is pushed out of the liquid chamber 2a is ejected as the droplets 20 from the nozzles 2d. Finally, by changing the voltage that is applied to the piezoelectric vibrator 2f, to which the voltage has been applied with the second voltage waveform Vw2, with the rectangular third voltage waveform Vw3 in which the volume of the liquid chamber 2a is restored to the volume in the standby state, the material solution 20 that is going to fall from the nozzles 2d following the ejected droplets 20 is sucked.

By changing the driving voltage that is applied to the piezoelectric vibrator 2f in order to eject the droplets 20 from the nozzles 2d in three phases of the first voltage waveform Vw1, the second voltage waveform Vw2, and the third waveform voltage Vw3, occurrence of cavitation in the liquid chamber 2a is prevented to prevent appearance of air bubbles, and ejection of the droplets 20 is favorably performed in succession, so that defective nozzles that have inappropriate amounts of ejected droplets as shown in FIG. 13 in the prior art are prevented.

While preferred embodiments of the present invention have been described above, it is to be understood that variations and modifications will be apparent to those skilled in the art without departing from the scope and spirit of the present invention. For example, although the first voltage waveform Vw1 that is applied to the piezoelectric vibrator 2f has four stages of the rise, the first voltage waveform Vw1 may have two stages, three stages, five stages, or six stages of the rise, and the number of stages is not limited.

1. A droplet ejection device that comprises a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism,
wherein the control mechanism is arranged to change the driving voltage, which is applied to the piezoelectric vibrator when increasing the volume of the liquid chamber so as to suck the material solution into the liquid chamber from the liquid supply channel, in stages such that the volume of the liquid chamber is increased in a plurality of stages.

2. A droplet ejection device that comprises a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism,
wherein the control mechanism is arranged to change the driving voltage, which is applied to the piezoelectric vibrator so as to eject the material solution from the nozzle, in three stages of
a step-like first voltage waveform in which the volume of the liquid chamber is increased in a plurality of stages so as to be greater than the volume in a standby state so that the material solution is sucked into the liquid chamber from the liquid supply channel,
a rectangular second voltage waveform in which the volume of the liquid chamber is decreased so as to be smaller than the volume in the standby state so that the droplets of the material solution are ejected from the nozzle, and
a third voltage waveform in which the volume of the liquid chamber is restored to the volume in the standby state.

3. A droplet ejection method for a droplet ejection device that comprises a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism,
wherein the control mechanism is arranged to change the driving voltage, which is applied to the piezoelectric vibrator when increasing the volume of the liquid chamber so as to suck the material solution into the liquid chamber from the liquid supply channel, in stages such that the volume of the liquid chamber is increased in a plurality of stages.

4. A droplet ejection method for droplet ejection device that comprises a nozzle, a liquid chamber that communicates with the nozzle and is arranged to accommodate a material solution that is supplied through a liquid supply channel, a piezoelectric vibrator that is provided to the liquid chamber, and a control mechanism arranged to apply a driving voltage to the piezoelectric vibrator, and is arranged to eject droplets of the material solution from the nozzle by increasing and decreasing a volume of the liquid chamber by the piezoelectric vibrator that is deformed in accordance with the driving voltage that is applied from the control mechanism,
wherein the control mechanism is arranged to change the driving voltage, which is applied to the piezoelectric vibrator so as to eject the material solution from the nozzle, in three stages of
a step-like first voltage waveform in which the volume of the liquid chamber is increased in a plurality of stages so as to be greater than the volume in a standby state so that the material solution is sucked into the liquid chamber from the liquid supply channel,
a rectangular second voltage waveform in which the volume of the liquid chamber is decreased so as to be smaller than the volume in the standby state so that the droplets of the material solution are ejected from the nozzle, and
a third voltage waveform in which the volume of the liquid chamber is restored to the volume in the standby state.
